(19) United States
(12) Patent Application Publication
(10) Pub. No.: US 2026/0346179 A1
(43) Pub. Date: Nov. 5, 2026

(54) APPARATUS AND METHOD FOR IODINE RECOVERY

(71) Applicants: SK Innovation Co., Ltd., Seoul (KR); SK On Co., Ltd., Seoul (KR)

(72) Inventors: Jae Hun JEONG, Daejeon (KR); Soo Kil KANG, Daejeon (KR); Dong Keun KIM, Daejeon (KR); Jisup SHIN, Daejeon (KR); Seung Ok LEE, Daejeon (KR); Ho Won LEE, Daejeon (KR); Hee Du LEE, Daejeon (KR); Jong Woo LIM, Daejeon (KR); Ju Hwan IM, Daejeon (KR)

(21) Appl. No.: 19/562,771

(22) Filed: Mar. 11, 2026

(30) Foreign Application Priority Data
Apr. 30, 2025 (KR) 10-2025-0057740
Apr. 30, 2025 (KR) 10-2025-0057752
Oct. 2, 2025 (KR) 10-2025-0145325
Oct. 2, 2025 (KR) 10-2025-0145397

(51) Int. Cl. B01D 53/00; C01B 7/14

(52) U.S. Cl. CPC B01D 53/002; C01B 7/14; B01D 2257/202

(57) ABSTRACT

An apparatus for iodine recovery includes a mixed gas supply unit configured to supply a mixed gas containing iodine; a plurality of iodine recovery units configured to receive the mixed gas and precipitate, as a solid, iodine from the mixed gas; a fluid supply unit configured to selectively supply a cooling medium or a heating medium to each of the plurality of iodine recovery units; and a switch disposed between the mixed gas supply unit and the plurality of iodine recovery units, configured to selectively switch a flow path of the mixed gas. The plurality of iodine recovery units includes a first iodine recovery unit and a second iodine recovery unit. The first iodine recovery unit precipitates, as a solid, the iodine in a cooling operation state, and the second iodine recovery unit removes accumulated iodine in a heating operation state.

### CROSS-REFERENCE TO RELATED APPLICATIONS

This application claims priority to Korean Patent Application No. 10-2025-0057740 filed on Apr. 30, 2025, Korean Patent Application No. 10-2025-0057752 filed on Apr. 30, 2025, Korean Patent Application No. 10-2025-0145397 filed on Oct. 2, 2025, and Korean Patent Application No. 10-2025-0145325 filed on Oct. 2, 2025, the disclosures of which are hereby incorporated by reference in their entireties.

### BACKGROUND

### Technical Field

The present disclosure relates to an apparatus and method for iodine recovery, and more particularly, to an apparatus and method for iodine recovery for precipitating and recovering iodine as a solid from a mixed gas.

### Technical Considerations

Iodine is a high value-added material used in various chemical processes, and technologies for recovering iodine from a mixed gas generated after a reaction are being studied.

Generally, a method of precipitating iodine as a solid through cooling is used to recover iodine from the mixed gas.

However, in this method, the precipitated iodine adheres to an inner wall of the apparatus, which may cause clogging of pipes, degradation of heat transfer efficiency, and process interruption. In particular, when solid iodine accumulates to a certain thickness or more, the above concerns are intensified, so there is a limitation in that it is difficult to perform a continuous process.

### SUMMARY

Embodiments of the present disclosure may provide an apparatus and method for iodine recovery, capable of solving concerns of pipe clogging, degradation of heat transfer efficiency, and difficulty in securing process continuity occurring in a process of precipitating and recovering iodine as a solid.

According to an embodiment of the present disclosure, an apparatus for iodine recovery may be provided. The apparatus may include a mixed gas supply unit configured to supply a mixed gas containing iodine; a plurality of iodine recovery units configured to receive the mixed gas and precipitate, as a solid, the iodine from the mixed gas; a fluid supply unit configured to selectively supply a cooling medium or a heating medium to each of the plurality of iodine recovery units; and a switch disposed between the mixed gas supply unit and the plurality of iodine recovery units, configured to selectively switch a flow path of the mixed gas. The plurality of iodine recovery units may include a first iodine recovery unit and a second iodine recovery unit. The first iodine recovery unit may precipitate, as a solid, the iodine in a cooling operation state, and the second iodine recovery unit may remove accumulated iodine in a heating operation state.

In some non-limiting embodiments, each of the plurality of iodine recovery units may comprise at least one of a double pipe structure or a heat exchange fin structure. In the double pipe structure, the mixed gas may flow along an inner pipe, cooling water may flow along an outer pipe, and the iodine may precipitate on an inner wall of the inner pipe. In the heat exchange fin structure, a plurality of heat exchange fins may be disposed inside a chamber, and the iodine may precipitate while the mixed gas flows along outer circumferential surfaces of the plurality of heat exchange fins.

In some non-limiting embodiments, the iodine recovery unit having the heat exchange fin structure may comprise: the chamber having a mixed gas inlet at one side and a mixed gas outlet at an opposite side; a heat medium plate disposed at an upper side of the chamber and having a heat medium flow path inside the heat medium plate; the plurality of heat exchange fins disposed inside the chamber; and a plurality of removal units disposed on an outer side of the plurality of heat exchange fins and configured to remove iodine precipitated on outer walls of the plurality of heat exchange fins from the mixed gas. The plurality of heat exchange fins may be connected to the heat medium plate to exchange heat with a heat medium flowing through the heat medium flow path, or may be fluidly connected to the heat medium flow path such that the heat medium flows inside the plurality of heat exchange fins. The plurality of removal units may comprise at least two of a scraper, a vibrator, a coating part, and a heater.

In some non-limiting embodiments, the scraper may comprise: a rotating body rotatably installed on outer circumferential surfaces of the plurality of heat exchange fins; and a plurality of blades coupled to the rotating body and fixed to the outer walls of the plurality of heat exchange fins, or coupled to the rotating body and moving along the outer walls of the plurality of heat exchange fins to scrape precipitated iodine. Alternatively, the scraper may be configured to scrape the precipitated iodine on the outer walls of the plurality of heat exchange fins by a moving body slidably installed on the outer circumferential surfaces of the plurality of heat exchange fins.

In some non-limiting embodiments, the vibrator may comprise a vibration generating unit coupled to the plurality of heat exchange fins, and the vibration generating unit may comprise an ultrasonic vibrator or a rotary motor-based vibrator.

In some non-limiting embodiments, the coating part may comprise an antifouling or water-repellent coating layer formed on the outer walls of the plurality of heat exchange fins, and the coating layer may be formed of a single layer or multiple layers including at least one of tetrafluoroethylene (TFE), polytetrafluoroethylene (PTFE), perfluoroalkoxy alkane (PFA), fluorinated ethylene propylene (FEP), polyethylene terephthalate (PET), or polydimethylsiloxane (PDMS).

In some non-limiting embodiments, the chamber may comprise a partition wall or a porous baffle disposed between the plurality of heat exchange fins and configured to control a flow of the mixed gas.

In some non-limiting embodiments, the switch may be configured to perform a switch operation to remove accumulated iodine from the second iodine recovery unit when the first iodine recovery unit is operated in a cooling operation state.

In some non-limiting embodiments, the switch may be operated by an electric switching control signal or a timer, and may be configured to alternately switch a flow path of the mixed gas based on an accumulation state of the iodine or an elapsed operation time.

In some non-limiting embodiments, the apparatus may further comprise a controller configured to control operations of the switch and the fluid supply unit. The controller may be configured to control the switch to selectively switch a flow path of the mixed gas, and control the fluid supply unit to selectively supply the cooling medium or the heating medium to each of the plurality of iodine recovery units.

In some non-limiting embodiments, a time point for switching the first iodine recovery unit or the second iodine recovery unit to a heating operation may be set to a time when a thickness of accumulated iodine reaches a set thickness.

In some non-limiting embodiments, the apparatus may further comprise: an iodine vaporization delivery line connected to the first iodine recovery unit or the second iodine recovery unit and configured to deliver iodine vaporized from the first iodine recovery unit or the second iodine recovery unit to the mixed gas supply unit; or a liquid iodine recovery tank configured to recover iodine liquefied in the first iodine recovery unit or the second iodine recovery unit.

According to an embodiment of the present disclosure, a method for iodine recovery may be provided. The method may comprise: supplying a mixed gas to a first iodine recovery unit among a plurality of iodine recovery units through a mixed gas supply unit; supplying a cooling medium to the first iodine recovery unit to precipitate, as a solid, iodine from the mixed gas; supplying a heating medium to a second iodine recovery unit disposed separately from the first iodine recovery unit to remove accumulated iodine; delivering the iodine removed from the second iodine recovery unit to the mixed gas supply unit or a liquid iodine recovery tank; and performing a switch operation to switch operation modes of the first iodine recovery unit and the second iodine recovery unit by switching a flow path of the mixed gas through a switch.

In some non-limiting embodiments, the method may further comprise: supplying the cooling medium to the second iodine recovery unit to precipitate, as a solid, the iodine by the switch operation. The supplying the cooling medium to the first iodine recovery unit to precipitate, as a solid, the iodine or supplying the cooling medium to the second iodine recovery unit to precipitate, as a solid, the iodine by the switch operation may be performed through: a double pipe structure in which the mixed gas flows along an inner pipe, cooling water flows along an outer pipe, and the iodine precipitates as a solid on an inner wall of the inner pipe; or a heat exchange fin structure in which the mixed gas flows along outer circumferential surfaces of a plurality of heat exchange fins disposed inside a chamber, and the iodine precipitates as a solid on the outer circumferential surfaces of the plurality of heat exchange fins.

In some non-limiting embodiments, the iodine recovery unit having the heat exchange fin structure may comprise: the chamber having a mixed gas inlet at one side and a mixed gas outlet at an opposite side; a heat medium plate disposed at an upper side of the chamber and having a heat medium flow path inside the heat medium plate; the plurality of heat exchange fins disposed inside the chamber; and a plurality of removal units disposed on an outer side of the plurality of heat exchange fins and configured to remove iodine precipitated on outer walls of the plurality of heat exchange fins from the mixed gas. The plurality of removal units may comprise at least two of a scraper, a vibrator, a coating part, and a heater.

In some non-limiting embodiments, the switch operation may be controlled by an electric switching control signal or a timer, and may alternately switch a flow path of the mixed gas based on an accumulation state of iodine or an elapsed operation time.

In some non-limiting embodiments, operations of the switch and a fluid supply unit supplying the cooling medium or the heating medium may be controlled by a control signal from a controller.

In some non-limiting embodiments, an inner wall temperature of the iodine recovery unit may be controlled to be maintained at a range from 30°C to 50°C through the fluid supply unit.

In some non-limiting embodiments, a time point for switching the first iodine recovery unit or the second iodine recovery unit to a heating operation may be set to a time when a thickness of accumulated iodine reaches a set thickness.

In some non-limiting embodiments, the method may further comprise delivering iodine vaporized in the first iodine recovery unit or the second iodine recovery unit to the mixed gas supply unit through an iodine vaporization delivery line.

In some non-limiting embodiments, iodine may be efficiently precipitated and recovered from a mixed gas containing iodine, and a continuous process may be performed by performing a switch operation on a plurality of recovery units.

In some non-limiting embodiments, pipe clogging or degradation of heat transfer efficiency occurring during a process of precipitating and recovering iodine as a solid may be minimized, thereby enabling stable iodine recovery and minimizing iodine loss.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating main parts of an apparatus for iodine recovery according to some non-limiting embodiments of the present disclosure.

FIG. 2 is a detailed block diagram illustrating main parts of an apparatus for iodine recovery according to some non-limiting embodiments of the present disclosure.

FIG. 3 is a schematic diagram illustrating connection relationships and flows between main components of an apparatus for iodine recovery according to some non-limiting embodiments of the present disclosure.

FIG. 4 is a schematic diagram illustrating an internal structure of an iodine recovery unit including a double pipe structure according to some non-limiting embodiments of the present disclosure.

FIG. 5 is a schematic diagram illustrating an internal structure of an iodine recovery unit including a heat exchange fin structure according to some non-limiting embodiments of the present disclosure.

FIG. 6 is a schematic diagram illustrating main parts of an iodine recovery unit including a heat exchange fin structure according to some non-limiting embodiments of the present disclosure.

FIG. 7 and FIG. 8 are schematic diagrams illustrating a scraper of an iodine recovery unit including a heat exchange fin structure according to some non-limiting embodiments of the present disclosure.

FIG. 9 is a schematic diagram illustrating a vibrator of an iodine recovery unit including a heat exchange fin structure according to some non-limiting embodiments of the present disclosure.

FIG. 10 is a schematic diagram illustrating a coating part of an iodine recovery unit including a heat exchange fin structure according to some non-limiting embodiments of the present disclosure.

FIG. 11 and FIG. 12 are schematic diagrams illustrating a heater of an iodine recovery unit including a heat exchange fin structure according to some non-limiting embodiments of the present disclosure.

FIG. 13 is a schematic diagram illustrating a support sheet of an iodine recovery unit including a heat exchange fin structure according to some non-limiting embodiments of the present disclosure.

FIG. 14 is a block diagram illustrating an iodine recovery unit including a heat exchange fin structure according to some non-limiting embodiments of the present disclosure.

FIG. 15 is a diagram illustrating a state in which a first iodine recovery unit is in a cooling operation mode and a second iodine recovery unit is in a heating operation mode in an apparatus for iodine recovery according to some non-limiting embodiments of the present disclosure.

FIG. 16 is a diagram illustrating a state in which a first iodine recovery unit is switched to a heating operation mode and a second iodine recovery unit is switched to a cooling operation mode in an apparatus for iodine recovery according to some non-limiting embodiments of the present disclosure.

FIG. 17 is a flowchart illustrating main steps of a method for iodine recovery according to some non-limiting embodiments of the present disclosure.

FIG. 18 is a flowchart illustrating control of a switch including performance of a switch operation and discharge of iodine in a method for iodine recovery according to some non-limiting embodiments of the present disclosure.

### DETAILED DESCRIPTION

Various embodiments or aspects will be described in detail with reference to the accompanying drawings. However, since various changes may be made in the embodiments or aspects, the scope of the patent disclosure is not limited or restricted by these embodiments or aspects. It should be understood that all modifications, equivalents, and alternatives for the embodiments or aspects are comprised in the scope of the present disclosure. For example, it is to be understood that the present disclosure may assume various alternative variations and step sequences, except where expressly specified to the contrary. It is also to be understood that the specific devices and processes illustrated in the attached drawings, and described in the following detailed description, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “comprise”, “comprises”, “comprising”, “include”, “includes”, “including”, “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

It will be understood that when a component is described to as being “connected,” “combined” or “coupled” to another component, the component may be directly connected or coupled to the another component, but it may be “connected,” “combined” or “coupled” to the another component by an intervening another component that may be present.

Further, in describing the components of the embodiment or aspect, the meaning of “or” may mean each of the components, may mean two or more of the components, or may mean all of the components. For example, it should be understood that the expressions “a, b or c” represent any one of “a,” “b,” “c,” “a and b,” “a and c,” “b and c,” and “a, b and c.”

Components comprised in one embodiment or aspect and components comprising common functions will be described using the same names in other embodiments or aspects. The description given in one embodiment or aspect may be applied to other embodiments or aspects, and therefore will not be described in detail within the overlapping range, unless there is a description opposite thereto.

The device and/or ‘data’ processed by the device may be expressed in terms of ‘information”. Here, the information may be used as a concept comprising the data.

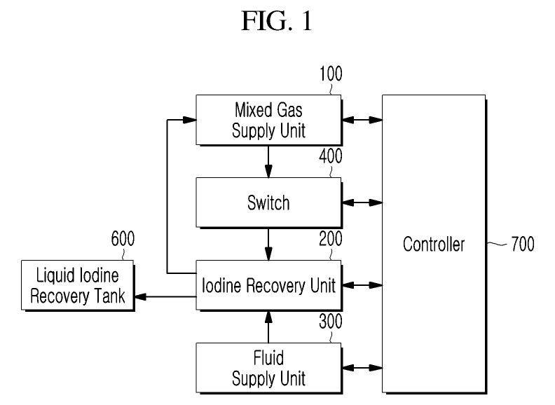

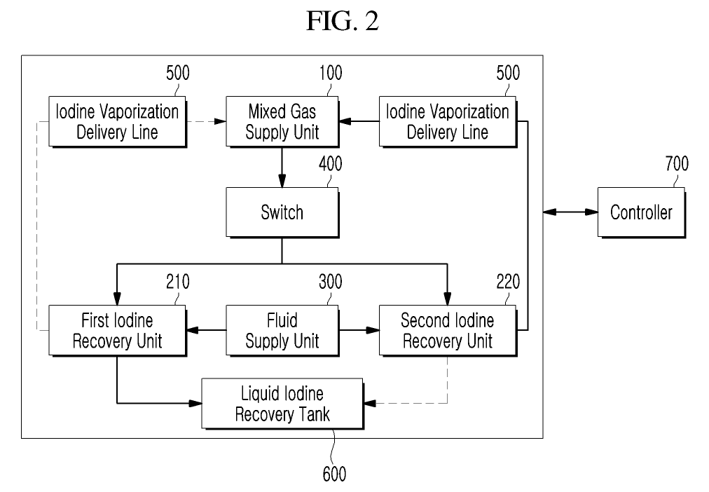

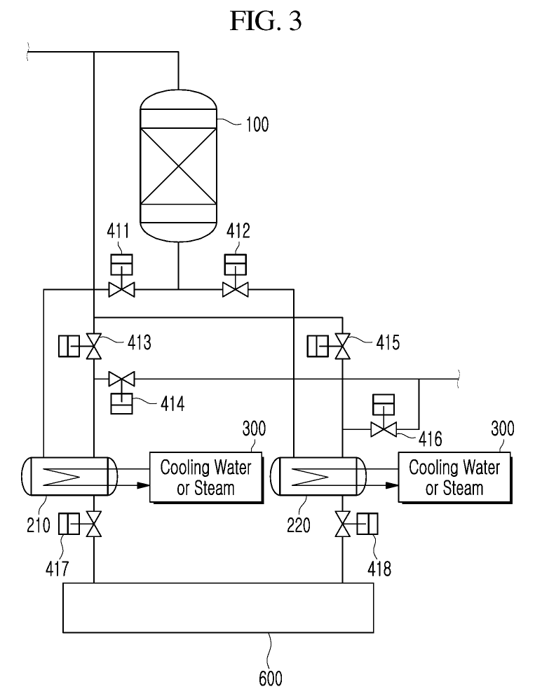

FIG. 1 is a block diagram illustrating main parts of an apparatus for iodine recovery according to an embodiment of the present disclosure. FIG. 2 is a detailed block diagram illustrating main parts of an apparatus for iodine recovery according to an embodiment of the present disclosure. FIG. 3 is a schematic diagram illustrating connection relationships and flows between main components of an apparatus for iodine recovery according to an embodiment of the present disclosure.

Referring to FIGS. 1 and 2, an apparatus for iodine recovery according to an embodiment of the present disclosure includes a mixed gas supply unit 100 configured to supply a mixed gas containing iodine, a plurality of iodine recovery units 200 into which the mixed gas flows to precipitate iodine as a solid, a fluid supply unit 300 configured to selectively supply a cooling medium or a heating medium to each of the plurality of iodine recovery units 200 and a switch 400 disposed between the mixed gas supply unit 100 and the plurality of iodine recovery units 200 and configured to selectively switch a flow path of the mixed gas. Among the plurality of iodine recovery units 200, a first iodine recovery unit 210 precipitates iodine as a solid in a cooling operation state, and a second iodine recovery unit 220 removes accumulated iodine 10 in a heating operation state.

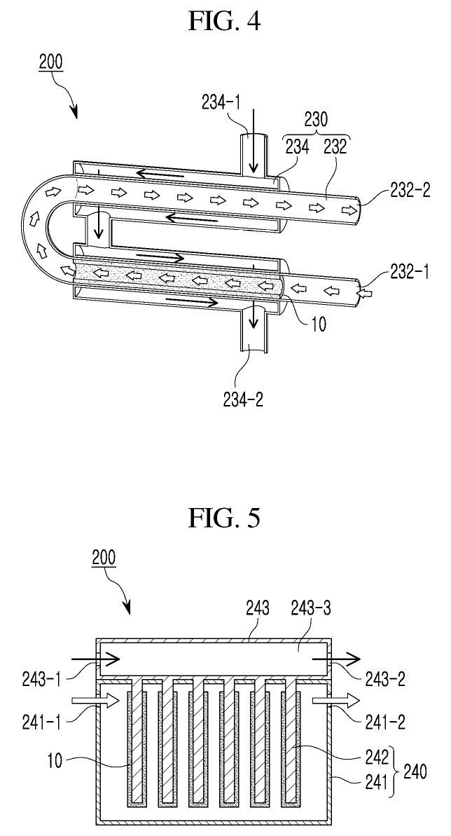

The apparatus for iodine recovery according to the present disclosure is capable of efficiently precipitating and removing iodine from a mixed gas containing iodine. The apparatus enables a dual operation mode consisting of a cooling operation for precipitating and recovering iodine as a solid within a recovery unit, and a heating operation for removing iodine 10 of FIG. 4 accumulated in another recovery unit. Through this, continuous operation may be possible.

The mixed gas supply unit 100 according to an embodiment of the present disclosure is configured to supply a mixed gas containing iodine. The mixed gas may be generated in a reactor or supplied from an external source through a supply line, and is supplied to the plurality of iodine recovery units 200.

The mixed gas supplied from the mixed gas supply unit 100 according to an embodiment of the present disclosure may contain iodine (I2) and a halogen-based hydrocarbon. A boiling point of substances excluding iodine may be 50°C or lower.

The mixed gas, which is a subject of treatment of the iodine recovery apparatus, is typically an exhaust gas generated from a chemical reaction or an iodide decomposition process, and gaseous iodine may be included in the exhaust gas.

The halogen-based hydrocarbon may include, for example, methyl iodide (CH3I), ethyl iodide (C2H5I), trifluoroiodomethane (CF3I), or low molecular weight fluorocarbon or chlorocarbon compounds structurally similar thereto.

These halogen-based hydrocarbons generally have higher volatility than iodine and may act as an auxiliary carrier gas and a reaction control gas in the mixed gas.

According to an embodiment, the boiling point of substances excluding iodine in the mixed gas may be 50°C or lower, so that components such as halogen-based hydrocarbons in the mixed gas are not easily condensed in the recovery unit 200 and are quickly discharged, thereby allowing selective recovery of only iodine.

This is to prevent substances other than iodine from being condensed or attached under conditions similar to iodine, considering that a temperature for maintaining high precipitation efficiency of iodine is in a range of about 30°C to 50°C (although the freezing point of iodine is about 110°C to 120°C, since iodine is a sublimable substance, the temperature needs to be lowered to about 30°C to 50°C to increase a recovery rate). That is, when the boiling point of substances excluding iodine is 50°C or lower, only iodine is condensed and recovered during the cooling operation, and the remaining substances may be maintained in a gaseous state and discharged.

According to a specific embodiment, the mixed gas supply unit 100 may contain iodine (I2) and methyl iodide (CH3I, boiling point of about 42°C). Iodine precipitates below 50°C, but CH3I has high volatility and is thus removed through an exhaust system without attaching to wall surfaces of the recovery unit 200. This enables recovery of only iodine and improves recovery efficiency through removal of impurities.

As described above, according to an embodiment of the present disclosure, only iodine (I2) in the mixed gas may be selectively condensed on a cooling wall surface (e.g., heat exchange fins) of the recovery unit 200, and substances excluding iodine may be set to have a boiling point of 50°C or lower so that they are not condensed in a heating or cooling process and are easily removed. Thus, purity and efficiency of iodine recovery may be improved. Through this, quality of recovered iodine may be enhanced.

The plurality of iodine recovery units 200 according to an embodiment of the present disclosure receives the mixed gas supplied from the mixed gas supply unit 100 and precipitates iodine as a solid on inner surfaces thereof. Each recovery unit 200 may have the same structure or different structures, and specifically, may selectively include a double pipe structure 230 of FIG. 4 or a heat exchange fin structure 240 of FIG. 5.

Each recovery unit 200 may be implemented in various shapes according to an inflow direction of the mixed gas, a structure, and a cooling or heating method. In this embodiment, an example consisting of two units, the first iodine recovery unit 210 and the second iodine recovery unit 220, will be described.

According to an embodiment, the first iodine recovery unit 210 may operate in a cooling operation state and precipitates iodine in the mixed gas on an inner wall thereof. In some embodiments, the second iodine recovery unit 220 may operate in a heating operation state and removes accumulated iodine 10 of FIG. 4.

Such a dual operation structure enables a continuous process, and continuous and interference-free recovery work can be possible by switching operation modes between the recovery units 200 through a switch operation.

According to an embodiment of the present disclosure, the iodine recovery unit 200 may include at least one of the double pipe structure 230 or the heat exchange fin structure 240.

The iodine recovery unit 200 according to an embodiment may include two units (e.g., the first iodine recovery unit 210 and the second iodine recovery unit 220) having operation modes independent of each other (cooling operation or heating operation). Each recovery unit 200 may include at least one of the double pipe structure 230 or the heat exchange fin structure 240.

The double pipe structure 230 according to an embodiment may include an inner pipe 232 and an outer pipe 234, as shown in FIG. 4. Referring to FIG. 4, while the mixed gas flows along the inner pipe 232, iodine may be precipitated or recovered on an inner wall of the inner pipe 232. Also, referring to FIG. 4, a cooling medium (e.g., cooling water) or a heating medium (e.g., steam) is supplied to the outer pipe 234 to perform heat exchange, thereby maintaining a temperature of the inner pipe 232 at a desired precipitation condition or recovery condition.

For example, the inner pipe 232 has a mixed gas inlet 232-1 formed at one side and a mixed gas outlet 232-2 formed at the other side so that the mixed gas flows along the inner pipe 232. The outer pipe 234 has a heat medium inlet 234-1 formed at one side and a heat medium outlet 234-2 formed at the other side so that the cooling medium (e.g., cooling water) or the heating medium (e.g., steam) may be supplied along the outer pipe 234.

For example, the inner pipe 232 may be formed of stainless steel, nickel alloy, or corrosion-resistant synthetic resin, and the outer pipe 234 may be formed of a metal or composite material having excellent thermal conductivity. In the double pipe structure 230, a flow of the cooling medium (e.g., cooling water) or the heating medium (e.g., steam) may be formed through a gap between the inner pipe 232 and the outer pipe 234, and the double pipe structure 230 may be formed in a concentric tubular structure or a polygonal tubular structure in cross-section.

In the heat exchange fin structure 240 according to an embodiment, a plurality of heat exchange fins 242 may be inserted and disposed inside a chamber 241, as shown in FIG. 5. Referring to FIG. 5, the mixed gas passes between the heat exchange fins 242, and heat transfer may occur on outer circumferential surfaces of the heat exchange fins 242. The heat exchange fins 242 are formed of a metal material or a highly conductive ceramic material, and the cooling medium (e.g., cooling water) or the heating medium (e.g., steam) is circulated along the outer circumferential surfaces to cool or heat the heat exchange fins 242.

For example, in the heat exchange fin structure 240, the mixed gas may be introduced into and discharged from the chamber 241 by the chamber 241 in which the plurality of heat exchange fins 242 are disposed, a mixed gas inlet 241-1 formed at one side of the chamber 241, and a mixed gas outlet 241-2 formed at the other side of the chamber 241. For example, a heat medium plate 243 connected to the heat exchange fins 242 may be formed at an upper side of the chamber 241. A heat medium inlet 243-1 and a heat medium outlet 243-2 may be formed at one side of the heat medium plate 243. The heat medium plate 243 may supply a heat medium (cooling medium or heating medium) to cool or heat the heat exchange fins 242 connected thereto.

The heat exchange fin structure 240 enables fast and uniform temperature distribution by increasing a heat transfer area relative to a flow path area, and a gap between the heat exchange fins 242 may be designed according to flow conditions and precipitation characteristics.

As described above, the iodine recovery unit according to an embodiment of the present disclosure includes at least one of the double pipe structure or the heat exchange fin structure, thereby effectively precipitating and removing iodine in the mixed gas and improving recovery efficiency.

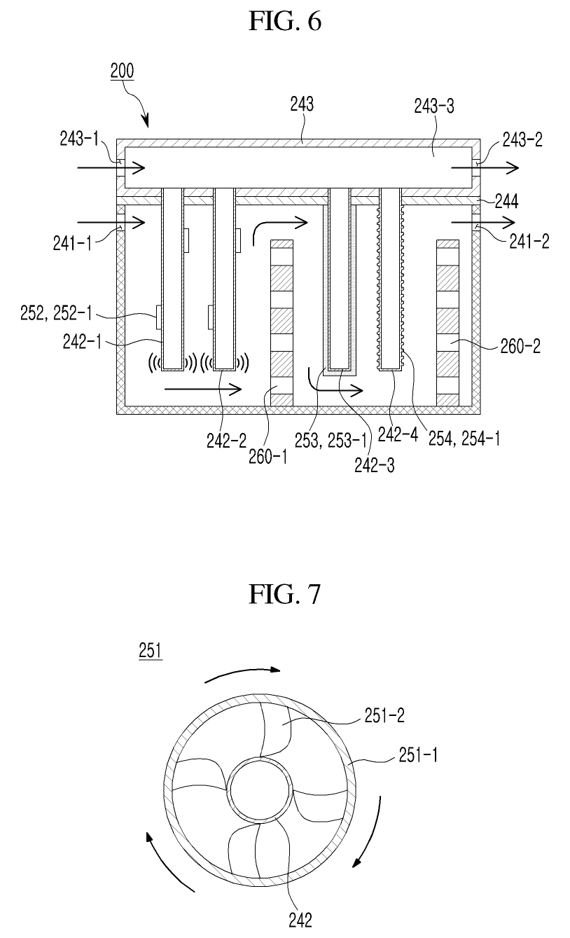

FIG. 6 is a schematic diagram illustrating main parts of an iodine recovery unit 200 including a heat exchange fin structure 240 according to an embodiment of the present disclosure.

Referring to FIG. 6, the iodine recovery unit 200 including the heat exchange fin structure 240 according to an embodiment of the present disclosure may include a chamber 241 having a mixed gas inlet 241-1 at one side and a mixed gas outlet 241-2 at an opposite side, a heat medium plate 243 disposed at an upper side of the chamber 241 and having a heat medium flow path 243-3 inside the heat medium plate, a plurality of heat exchange fins 242 disposed inside the chamber 241, connected to the heat medium plate 243 to exchange heat with a heat medium flowing through the heat medium flow path 243-3, or fluidly connected to the heat medium flow path 243-3 such that the heat medium flows inside the plurality of heat exchange fins 242 and a plurality of removal units 250 formed on an outer side of the plurality of heat exchange fins 242 and configured to remove iodine precipitated on outer walls of the plurality of heat exchange fins 242 from the mixed gas. The plurality of removal units 250 may include at least two of a scraper 251, a vibrator 252, a coating part 253, and a heater 254.

The iodine recovery unit 200 of the apparatus for iodine recovery according to an embodiment of the present disclosure may include a heat exchange structure and the removal unit 250 for cooling the mixed gas containing gaseous iodine to precipitate iodine, and physically removing iodine accumulated on outer walls of the heat exchange fins 242, 242-1, 242-2, 242-3, and 242-4.

In the chamber 241 according to an embodiment of the present disclosure, the heat medium plate 243 may be formed at an upper portion, and the heat medium flow path 243-3 may be formed in the heat medium plate 243 so that the heat medium may circulate. The heat medium plate 243 is located at the upper side of the chamber 241, and the heat medium inlet 243-1 and the heat medium outlet 243-2 may be respectively formed at both sides of the heat medium plate 243 so that the heat medium flows in one direction. A flow direction of the heat medium is not limited thereto.

The chamber 241 according to an embodiment of the present disclosure is generally made of a metal material, and may be formed of a material having excellent thermal conductivity and corrosion resistance to stably perform heat exchange while accommodating the mixed gas. In an embodiment, the plurality of heat exchange fins 242, 242-1, 242-2, 242-3, and 242-4 may be disposed inside the chamber 241, and the mixed gas flows along outer sides of the heat exchange fins 242, 242-1, 242-2, 242-3, and 242-4 and may be cooled to precipitate iodine in the mixed gas.

According to an embodiment of the present disclosure, the mixed gas inlet 241-1 may be formed at one side of the chamber 241, and the mixed gas outlet 241-2 may be formed at the other side thereof.

The mixed gas inlet 241-1 and the mixed gas outlet 241-2 may serve to introduce a high-temperature exhaust gas (mixed gas) containing iodine generated from a reactor into the chamber 241 and discharge the cooled exhaust gas to the outside, respectively. The mixed gas may be cooled while flowing along outer sides of the heat exchange fins 242, 242-1, 242-2, 242-3, and 242-4, and in this process, gaseous iodine may be precipitated on outer walls of the heat exchange fins 242, 242-1, 242-2, 242-3, and 242-4.

The plurality of heat exchange fins (Cooling Tubes) 242, 242-1, 242-2, 242-3, and 242-4 according to an embodiment of the present disclosure may be disposed inside the chamber 241, and may be connected to the heat medium plate 243 to exchange heat with a heat medium flowing through the heat medium flow path 243-3, or may communicate with the heat medium flow path 243-3 and be formed in a tubular shape such that the heat medium flows therein. In the embodiment of FIG. 5, heat exchange fins 242 connected to the heat medium plate 243 are illustrated, and in the embodiments of FIGS. 6 - 13, tubular heat exchange fins whose insides communicate with the heat medium flow path are illustrated.

Referring to FIGS. 5 and 6, the plurality of heat exchange fins 242, 242-1, 242-2, 242-3, and 242-4 according to an embodiment of the present disclosure may be installed inside the chamber 241 at intervals spaced apart from each other, and may be arranged in parallel along a flow direction of the mixed gas.

A large number of the plurality of heat exchange fins 242, 242-1, 242-2, 242-3, and 242-4 may be installed inside the chamber 241 from the mixed gas inlet 241-1 into which the mixed gas is introduced to the mixed gas outlet 241-2 from which a residual gas after heat exchange is discharged to the outside. Each of the heat exchange fins 242, 242-1, 242-2, 242-3, and 242-4 may be disposed to be spaced apart from each other. The spacing interval may be designed according to a cross-sectional size of a heat exchanger, a flow rate of the mixed gas, etc., and generally allows uniform heat exchange and iodine precipitation by being arranged at regular intervals.

In an embodiment, the heat exchange fins 242, 242-1, 242-2, 242-3, and 242-4 may be arranged in parallel along the flow direction of the mixed gas, that is, a direction from the mixed gas inlet 241-1 to the mixed gas outlet 241-2. This minimizes flow resistance of the mixed gas, allows a cooling effect to be uniformly distributed, and allows an amount or position of iodine precipitated in each of the heat exchange fins 242, 242-1, 242-2, 242-3, and 242-4 to be dispersed.

As described above, according to an embodiment of the present disclosure, the mixed gas may be cooled while uniformly passing between the plurality of heat exchange fins 242, 242-1, 242-2, 242-3, and 242-4 arranged in parallel, and accordingly, heat exchange may occur in the heat exchange fins 242, 242-1, 242-2, 242-3, and 242-4 to precipitate iodine, thereby improving overall iodine recovery efficiency.

Referring to FIG. 5, the heat exchange fins 242, 242-1, 242-2, 242-3, and 242-4 according to an embodiment of the present disclosure may be formed in a cylindrical structure made of a metal material, and one end thereof may be connected to the heat medium flow path 243-3.

The plurality of heat exchange fins 242, 242-1, 242-2, 242-3, and 242-4 are heat exchangers installed inside the chamber 241, and may lower a temperature of the mixed gas through heat exchange with the heat medium. For example, each of the heat exchange fins 242, 242-1, 242-2, 242-3, and 242-4 may be formed in a cylindrical structure, and may be arranged in parallel along an exhaust gas flow path. However, shapes and arrangement methods of the heat exchange fins are not limited thereto.

A material of the heat exchange fins 242, 242-1, 242-2, 242-3, and 242-4 according to an embodiment may be a metal material having excellent thermal conductivity and corrosion resistance to iodine and the mixed gas. For example, an alloy material having high heat resistance and high corrosion resistance properties, such as stainless steel or titanium alloy, may be used.

Referring to FIG. 6, one end of each of the heat exchange fins 242, 242-1, 242-2, 242-3, and 242-4 according to an embodiment may be connected to the heat medium flow path 243-3 through which the heat medium is introduced and discharged. The heat medium flow path 243-3 is formed in an upper portion of the chamber 241 or in the heat medium plate 243, and the heat medium may be supplied into the heat exchange fins 242, 242-1, 242-2, 242-3, and 242-4 through the heat medium plate 243 and flow downward or upward along each of the heat exchange fins 242, 242-1, 242-2, 242-3, and 242-4.

For example, the heat exchange fins 242, 242-1, 242-2, 242-3, and 242-4 may communicate with the heat medium flow path 243-3 at an upper end thereof so that the heat medium forms a circulation flow, thereby maintaining a constant temperature of outer walls of the heat exchange fins 242, 242-1, 242-2, 242-3, and 242-4.

As described above, according to an embodiment of the present disclosure, the metal heat exchange fins 242, 242-1, 242-2, 242-3, and 242-4 may be connected to the heat medium plate 243 or fluidly connected to the heat medium flow path 243-3 of the heat medium plate 243 to increase heat conduction efficiency and maintain the temperature of the outer walls of the heat exchange fins 242, 242-1, 242-2, 242-3, and 242-4 in an iodine precipitation temperature range of 30°C to 50°C, thereby improving iodine recovery efficiency.

According to an embodiment of the present disclosure, a plurality of removal units 250 for removing precipitated iodine, as shown in FIG. 14, may be disposed on an outer side of the heat exchange fins 242, 242-1, 242-2, 242-3, and 242-4.

In an embodiment, the removal unit 250 may include at least two of a scraper 251, a vibrator 252, a coating part 253, and a heater 254.

The scraper 251 physically contacts outer walls of the heat exchange fins 242, 242-1, 242-2, 242-3, and 242-4 to scrape off precipitated iodine.

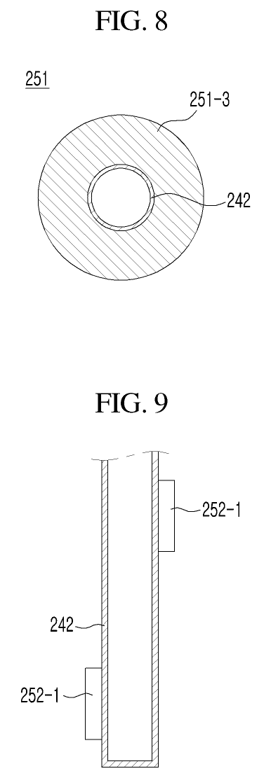

FIG. 7 and FIG. 8 are schematic diagrams illustrating a scraper 251 of an iodine recovery unit 200 according to an embodiment of the present disclosure.

Referring to FIGS. 5, 6 and 7, the scraper 251 according to an embodiment of the present disclosure may include a rotating body 251-1 rotatably installed on outer circumferential surfaces of the heat exchange fins 242, 242-1, 242-2, 242-3, and 242-4 and a plurality of blades 251-2 coupled to the rotating body 251-1 and configured to be fixed to the outer walls of the heat exchange fins 242, 242-1, 242-2, 242-3, and 242-4, or coupled to the rotating body 251-1 and moving along the outer walls of the heat exchange fins 242, 242-1, 242-2, 242-3, and 242-4 to scrape off precipitated iodine.

The scraper 251 according to an embodiment may include the rotating body 251-1 rotatably installed along the outer circumferential surfaces of the heat exchange fins 242, 242-1, 242-2, 242-3, and 242-4. The rotating body 251-1 is generally formed in a circular ring shape, and may be disposed inside the chamber 241 in a form surrounding the heat exchange fins 242, 242-1, 242-2, 242-3, and 242-4. For example, the rotating body 251-1 may be disposed in a circular arc direction or a spiral shape with respect to the outer circumferential surfaces of the heat exchange fins 242, 242-1, 242-2, 242-3, and 242-4, and a support structure and a driving means may be coupled thereto to perform a rotational motion with respect to the heat exchange fins 242, 242-1, 242-2, 242-3, and 242-4. For example, the rotating body 251-1 may be driven by a rotation method using an electric motor.

According to an embodiment, the plurality of blades 251-2 may be coupled to the rotating body 251-1. The blades 251-2 are fixed to an inner circumferential surface of the rotating body 251-1, and may move along the outer walls of the heat exchange fins 242, 242-1, 242-2, 242-3, and 242-4 or scrape off precipitated iodine in a fixed state as the rotating body 251-1 rotates. The blades 251-2 may be formed of a material having constant elasticity, for example, a silicone rubber or fluororesin (e.g., PTFE) material having excellent heat resistance and abrasion resistance, and may be in close contact with shapes of the outer walls of the heat exchange fins 242, 242-1, 242-2, 242-3, and 242-4 to perform a continuous scraping operation. In addition, the blades 251-2 may be variously formed in a linear, curved, or V-shaped structure according to curvatures and arrangement intervals of the heat exchange fins 242, 242-1, 242-2, 242-3, and 242-4.

According to an embodiment, the rotating body 251-1 and the blades 251-2 may be installed across the entire array of the heat exchange fins 242, 242-1, 242-2, 242-3, and 242-4, and one rotating body 251-1 may be formed to simultaneously scrape the plurality of heat exchange fins 242, 242-1, 242-2, 242-3, and 242-4, or an independent rotating body 251-1 and blade 251-2 combination may be installed for each of the heat exchange fins 242, 242-1, 242-2, 242-3, and 242-4.

Such a structure may improve uniformity and efficiency of scraping, and simultaneously improve maintainability of the apparatus. In addition, a rotation cycle of the rotating body 251-1 and pressing strength of the blades 251-2 may be automatically adjusted by the controller 700 according to an accumulation rate and thickness of precipitated iodine.

Referring to FIGS. 5, 6 and 8, the scraper 251 according to an embodiment of the present disclosure may scrape off precipitated iodine on the outer walls of the heat exchange fins 242, 242-1, 242-2, 242-3, and 242-4 by a moving body 251-3 slidably installed on the outer circumferential surfaces of the heat exchange fins 242, 242-1, 242-2, 242-3, and 242-4.

The scraper 251 may include the moving body 251-3 capable of sliding movement along the outer circumferential surfaces of the heat exchange fins 242, 242-1, 242-2, 242-3, and 242-4. The moving body 251-3 may move along a length direction or the outer circumferential surfaces of the heat exchange fins 242, 242-1, 242-2, 242-3, and 242-4 along a linear guide or a track structure. For example, the moving body 251-3 may be driven in a linear direction through a linear actuator.

The moving body 251-3 according to an embodiment may directly contact the outer walls of the heat exchange fins 242, 242-1, 242-2, 242-3, and 242-4, or a scraping blade or a scraping pad may be coupled to the moving body 251-3. This is installed to be in close contact with the outer walls of the heat exchange fins 242, 242-1, 242-2, 242-3, and 242-4 with a constant pressure to scrape off precipitated iodine, and may be made of a wear-resistant material such as silicone rubber, fluororesin (e.g., PTFE), or a stainless brush.

For example, a position of the moving body 251-3 may be detected by a sensor and a controller, and a movement speed, a movement distance, and an operation cycle may be automatically adjusted according to a precipitation amount. Also, a plurality of moving bodies 251-3 may be individually installed for each of the heat exchange fins 242, 242-1, 242-2, 242-3, and 242-4, or one moving body 251-3 may be formed in a structure that simultaneously scrapes the outer walls of the plurality of heat exchange fins 242, 242-1, 242-2, 242-3, and 242-4.

According to an embodiment of the present disclosure, the scraper 251 may be disposed in a temperature region of 30°C to 50°C, which is an iodine precipitation temperature range, among the outer walls of the heat exchange fins 242, 242-1, 242-2, 242-3, and 242-4.

By reflecting thermodynamic conditions in which iodine transitions from a gas phase to a solid phase and precipitates on the outer walls of the heat exchange fins 242, 242-1, 242-2, 242-3, and 242-4, and concentrating the scraping action on a section where substantial iodine accumulation occurs, iodine removal efficiency may be increased.

Outer wall temperatures of the heat exchange fins 242, 242-1, 242-2, 242-3, and 242-4 may be controlled as a heat medium supplied through the heat medium flow path 243-3 communicating with the heat medium plate 243 flows therein, and iodine precipitation conditions are formed according to heat exchange with the mixed gas. Typically, iodine phase-changes from gas to solid at about 110°C or lower at atmospheric pressure, but in order to increase an iodine recovery rate, iodine needs to phase-change from gas to solid in a range of 30°C to 50°C.

Accordingly, the scraper 251 may be selectively disposed in a region corresponding to the above temperature range among the outer walls of the heat exchange fins 242, 242-1, 242-2, 242-3, and 242-4. Such selective placement allows efficient operation only at substantial precipitation points in the entire heat exchange fins 242, 242-1, 242-2, 242-3, and 242-4, thereby minimizing energy consumption and wear of the entire apparatus. For example, the scraper 251 may be intensively disposed at a middle point excluding upper ends and lower ends of the heat exchange fins 242, 242-1, 242-2, 242-3, and 242-4.

According to an embodiment, the scraper 251 may apply either the rotating body structure or the moving body structure, and a driving unit may be disposed within the corresponding temperature region. After pre-analyzing temperature distribution of the outer walls of the heat exchange fins 242, 242-1, 242-2, 242-3, and 242-4 through thermal simulation or thermocouple-based actual measurement, an actual placement height and position of the scraper 251 may be determined. Also, a structure in which a plurality of scrapers 251 may be dividedly arranged for one heat exchange fin 242, 242-1, 242-2, 242-3, or 242-4 may be applied.

As described above, the temperature-based placement of the scraper 251 according to an embodiment of the present disclosure concentrates a scraping function on the temperature region of 30°C to 50°C where iodine precipitation substantially occurs on the outer walls of the heat exchange fins 242, 242-1, 242-2, 242-3, and 242-4, thereby improving energy efficiency and preventing unnecessary wear.

FIG. 9 is a schematic diagram illustrating a vibrator according to an embodiment of the present disclosure.

Referring to FIGS. 5, 6 and 9, the vibrator 252 according to an embodiment of the present disclosure induces detachment of iodine by applying vibration to the heat exchange fins 242, 242-1, 242-2, 242-3, and 242-4. An ultrasonic vibrator or a rotary motor-based vibrator may be used as a vibration generating unit 252-1. This transmits mechanical or acoustic vibration to the heat exchange fins 242, 242-1, 242-2, 242-3, and 242-4 to detach iodine attached to outer walls of the heat exchange fins 242, 242-1, 242-2, 242-3, and 242-4 in a non-contact manner.

According to an embodiment, the vibrator 252 may be disposed to be directly coupled to the heat exchange fins 242, 242-1, 242-2, 242-3, and 242-4 so that vibration propagating along the heat exchange fins 242, 242-1, 242-2, 242-3, and 242-4 affects the iodine precipitation layer. The installation of the vibrator 252 induces detachment of iodine crystals formed on the outer walls of the heat exchange fins 242, 242-1, 242-2, 242-3, and 242-4 for a certain period of time before they are fixed with strong cohesive force. When used in combination with the scraper 251, the coating part 253, and the heater 254, detachment efficiency may be further improved.

The ultrasonic vibrator according to an embodiment generally may have a frequency of several tens of kHz or more, and may transmit high-frequency acoustic energy to the outer walls of the heat exchange fins 242, 242-1, 242-2, 242-3, and 242-4 by setting a resonance frequency according to materials and thicknesses of the heat exchange fins 242, 242-1, 242-2, 242-3, and 242-4. Accordingly, cohesive force of precipitated iodine may be weakened to induce physical detachment. One or more ultrasonic vibrators may be attached directly mainly to outer surfaces of the heat exchange fins 242, 242-1, 242-2, 242-3, and 242-4.

The rotary motor-based vibrator according to an embodiment may generate mechanical vibration in the heat exchange fins 242, 242-1, 242-2, 242-3, and 242-4, and may be disposed at one side of the heat exchange fins 242, 242-1, 242-2, 242-3, and 242-4.

As described above, by providing the vibrator 252 according to an embodiment of the present disclosure, a detachment rate of iodine attached to the outer walls of the heat exchange fins 242, 242-1, 242-2, 242-3, and 242-4 may be improved, and a load on the scraper 251 or the heater 254 may be reduced. In addition, since iodine may be removed in a non-contact manner without physical damage, it is advantageous for maintaining a lifespan of the heat exchange fins 242, 242-1, 242-2, 242-3, and 242-4. In particular, when the ultrasonic vibrator is used, a residue dispersion effect is generated by periodic vibration, thereby reducing a maintenance frequency of the apparatus.

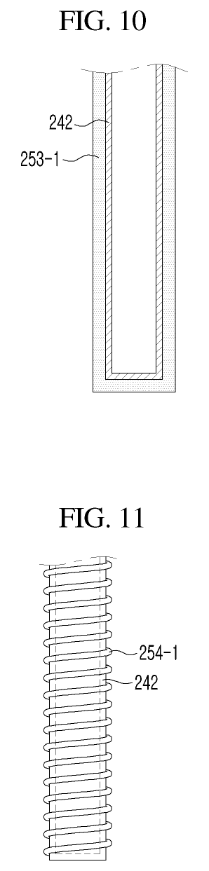

FIG. 10 is a schematic diagram illustrating a coating part according to an embodiment of the present disclosure.

Referring to FIGS. 5, 6 and 10, the coating part 253 according to an embodiment of the present disclosure may form an antifouling or water-repellent coating layer 253-1 on outer walls of the heat exchange fins 242, 242-1, 242-2, 242-3, and 242-4 to delay iodine precipitation or facilitate detachment.

The coating part 253 may form the coating layer 253-1 to prevent iodine from precipitating on the outer walls of the heat exchange fins 242, 242-1, 242-2, 242-3, and 242-4, or to facilitate detachment even if precipitated. The coating part 253 may be selectively formed on each outer wall of the plurality of heat exchange fins 242, 242-1, 242-2, 242-3, and 242-4, thereby preventing fixation and crystallization during a process in which gaseous iodine in the mixed gas is condensed, congealed, or precipitated as a solid on the outer walls of the heat exchange fins 242, 242-1, 242-2, 242-3, and 242-4. This reduces adhesion strength of iodine and reduces an operation load of the removal unit 250.

The coating part 253 according to an embodiment may include the antifouling or water-repellent coating layer 253-1 formed on the outer walls of the heat exchange fins 242, 242-1, 242-2, 242-3, and 242-4. The coating layer 253-1 may suppress chemical bonding with iodine or other components in the mixed gas, and may physically provide low surface energy so that condensation droplets or crystal nuclei do not adhere to the surface.

For example, the antifouling coating layer 253-1 may have a property of lowering surface roughness and reducing adhesion, and the water-repellent coating layer 253-1 may prevent condensed moisture from mediating cohesion with iodine.

The coating layer 253-1 may be formed on surfaces of the heat exchange fins 242, 242-1, 242-2, 242-3, and 242-4 by various methods such as deposition, spraying, spin coating, or dip coating, and if necessary, surface strength and durability may be enhanced through a heat treatment or curing process.

According to an embodiment, various chemically stable fluorine-based resins or polymer resins (e.g., siloxane-based resins, etc.) may be applied to the coating layer 253-1. For example, at least one of tetrafluoroethylene (TFE), polytetrafluoroethylene (PTFE), perfluoroalkoxy alkane (PFA), fluorinated ethylene propylene (FEP), polyethylene terephthalate (PET), etc. may be used. These materials have excellent resistance to high temperatures and chemicals and low surface energy, resulting in low adhesion to iodine. The siloxane-based resin is, for example, polydimethylsiloxane (PDMS) or a siloxane derivative, and has high elasticity and antifouling properties.

For example, tetrafluoroethylene has excellent high-temperature heat resistance and chemical stability, and reduces adhesion of iodine, which is advantageous for accumulation control. Perfluoroalkoxy alkane resin is a fluorine-based polymer providing excellent chemical resistance and abrasion resistance, and ensures durability against repeated cooling and heating operations. Polytetrafluoroethylene has very low surface energy, allowing iodine to be easily separated without strongly adhering to an inner wall surface even if condensed as a solid. Polyethylene terephthalate is relatively economical and has excellent coating workability along with physical strength, which is advantageous for forming a uniform thin film coating on the inner wall surface.

According to an embodiment, the coating part 253 may be uniformly applied to the entire outer walls of the heat exchange fins 242, 242-1, 242-2, 242-3, and 242-4. The coating layer 253-1 may be formed by spraying a fluorine-based resin together with a solvent to coat after surface modification pretreatment (e.g., plasma treatment), and then curing (e.g., in an oven at 150°C for 30 minutes) the resin. In addition, a double-layer coating structure in which a thin inorganic protective film (e.g., SiO2-based coating) is additionally deposited on the coating layer 253-1 may be applied to prevent detachment or damage of the coating layer 253-1 during apparatus operation.

The coating part 253 may be coated as a single layer or formed as multiple layers by stacking two or more materials. In the case of multiple layers, for example, by combining PTFE and PET, a coating layer having both abrasion resistance and anti-adhesion characteristics may be formed.

Here, the coating layer may also be formed on an inner wall of the inner pipe 232 in the double pipe structure 230. That is, it may be formed on a surface within the iodine recovery unit 200 where heat exchange occurs.

As described above, by providing the coating part 253 according to an embodiment of the present disclosure, precipitation of iodine on the outer walls of the heat exchange fins 242, 242-1, 242-2, 242-3, and 242-4 may be prevented, and a load on other removal units 250 may be reduced even if precipitated.

Also, the coating part according to an embodiment of the present disclosure may prevent excessive adhesion or non-uniform accumulation when iodine precipitates on an inner wall of the iodine recovery unit, thereby facilitating control of accumulated thickness and improving iodine removal efficiency during a heating operation.

FIG. 11 is a schematic diagram illustrating a heater according to an embodiment of the present disclosure.

Referring to FIGS. 5, 6 and 11, the heater 254 according to an embodiment of the present disclosure may heat and detach iodine by disposing a heater 254-1 or a heat medium supply unit 254-2 on outer walls of the heat exchange fins 242, 242-1, 242-2, 242-3, and 242-4.

Also, according to an embodiment, iodine may be heated and detached by supplying a heat medium to the heat medium inlet 243-1. In this case, supply of a cooling medium may be stopped and a heating medium may be supplied to the heat medium inlet 243-1.

The heater 254 may remove precipitated iodine by selectively heating the outer walls of the heat exchange fins 242, 242-1, 242-2, 242-3, and 242-4 in consideration of a melting point and sublimation characteristics of iodine. For example, the heater 254 generally applies heat locally or entirely to a part or the entire outer surfaces of the heat exchange fins 242, 242-1, 242-2, 242-3, and 242-4 to reduce adhesion strength of an iodine precipitation layer, and simultaneously sublimates or melts condensed iodine, thereby inducing a state in which the iodine can be easily removed physically.

Referring to FIGS. 5, 6 and 11, the heater 254-1 according to an embodiment of the present disclosure may include an electric resistance heating element, and may be in direct contact with or attached in an insulated state to the outer walls of the heat exchange fins 242, 242-1, 242-2, 242-3, and 242-4. According to an embodiment, the heater 254-1 may be formed of a thin-film resistance heating element based on a polyimide film, wraps around outer circumferential surfaces of the heat exchange fins 242, 242-1, 242-2, 242-3, and 242-4 in a spiral shape or the like, and may perform local heating to a temperature higher than an iodine precipitation temperature (e.g., 60°C or higher) through a controller.

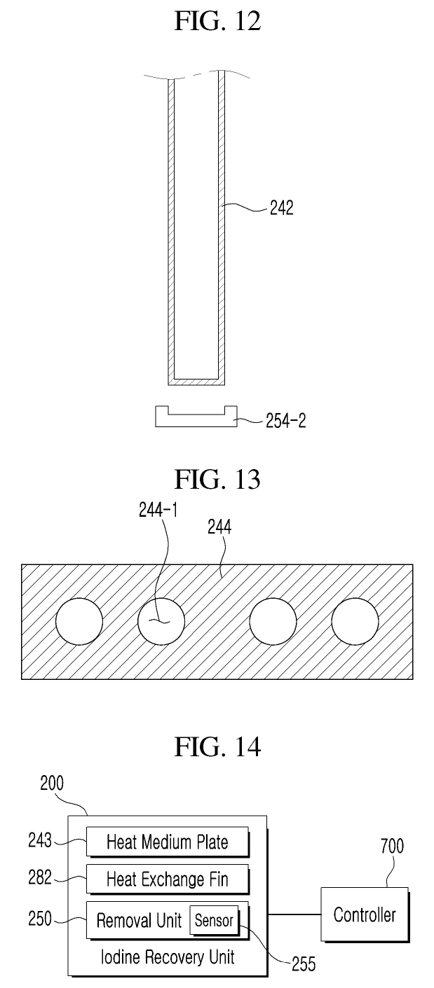

Referring to FIGS. 5, 6 and 12, the heater 254 may include a heat medium supply unit 254-2 that heats the outer walls of the heat exchange fins 242, 242-1, 242-2, 242-3, and 242-4 through direct delivery of high-temperature steam. For example, heat may be directly transferred to the iodine precipitation layer through the heat medium supply unit 254-2 disposed at a lower side or a periphery of the heat exchange fins 242, 242-1, 242-2, 242-3, and 242-4.

According to an embodiment, the heater 254 may be operated in parallel with or complementarily to the scraper 251, the vibrator 252, and the coating part 253. In particular, when gaseous iodine is condensed on the outer walls of the heat exchange fins 242, 242-1, 242-2, 242-3, and 242-4 to form a thick precipitation layer, it is effective to transform iodine into a detachable state by operating the heater 254 before physically removing the iodine. Through this, wear of the blades 251-2 may be reduced, vibration energy consumption may be minimized, and it may contribute to maintaining durability of the coating layer 253-1.

According to an embodiment of the present disclosure, the heater 254 may be operated based on a set time period or an accumulated thickness of precipitated iodine.

For example, by controlling the heater 254 to be automatically driven through the controller at predetermined time intervals based on an operation time or a number of cycles of the system, iodine may be periodically detached before being excessively accumulated.

In addition, the heater 254 may be operated based on the accumulated thickness of precipitated iodine. Specifically, a thickness measuring sensor is installed on the outer walls of the heat exchange fins 242, 242-1, 242-2, 242-3, and 242-4 to monitor the accumulated thickness of iodine in real time, and when the thickness exceeds a threshold value, the heater 254 may be operated.

As described above, according to an embodiment of the present disclosure, by controlling the heater 254 based on a period or a thickness, overheating or unnecessary operation of the heater 254 may be prevented to minimize energy waste, and lifespan and operation efficiency of the apparatus may be improved.

According to an embodiment of the present disclosure, a partition wall or a porous baffle 260-1 and 260-2 selectively formed between the arrangement of the heat exchange fins 242, 242-1, 242-2, 242-3, and 242-4 may be included inside the chamber 241 to control a flow of the mixed gas.

The partition wall or the porous baffle 260-1 and 260-2 may be formed inside the chamber 241, particularly in intervals or gaps between the plurality of heat exchange fins 242, 242-1, 242-2, 242-3, and 242-4, and may control cooling efficiency by adjusting a residence time of the mixed gas.

The partition walls 260-1 and 260-2 may be formed in a shape that directly blocks or detours a flow direction of the mixed gas, and may be formed in, for example, a plate-like or corrugated (curved) structure made of a metal or heat-resistant ceramic material. The porous baffles 260-1 and 260-2 are structures having fine pores, are formed to allow the mixed gas to pass through while receiving a certain flow resistance, and may be formed of, for example, a metal perforated plate.

Referring back to FIG. 6, the partition wall or the porous baffle 260-1 and 260-2 may be disposed to partition the inside of the chamber 241 or separate a flow path. For example, it may extend from a bottom portion of the chamber 241 toward an upper side, and be disposed to be spaced apart from an upper inner wall of the chamber 241 so that a flow path is formed.

Accordingly, according to an embodiment of the present disclosure, by adjusting the flow and residence time of the mixed gas within the chamber 241, stable heat exchange may be performed with respect to the heat exchange fins 242, 242-1, 242-2, 242-3, and 242-4, thereby improving overall iodine recovery efficiency.

FIG. 13 is a schematic diagram illustrating a support sheet according to an embodiment of the present disclosure.

Referring to FIGS. 5, 6 and 13, the support sheet 244 according to an embodiment of the present disclosure may be located between the chamber 241 and the heat medium plate 243, fixes and supports the plurality of heat exchange fins 242, 242-1, 242-2, 242-3, and 242-4, and allows the heat medium plate 243 to be opened and closed from the chamber 241. That is, the chamber 241 and the heat medium plate 243 may be separated via the support sheet 244.

The support sheet 244 according to an embodiment of the present disclosure may be located at a lower side of the heat medium plate 243 and fix and support the plurality of heat exchange fins 242, 242-1, 242-2, 242-3, and 242-4 so that intervals and alignment thereof are maintained. It is generally formed in a metal flat plate structure, and a plurality of coupling holes 244-1 may be disposed so that the individual heat exchange fins 242, 242-1, 242-2, 242-3, and 242-4 may be inserted.

The heat medium plate 243 may be openable and closable with respect to the chamber 241 or detachable from the chamber 241, so that removal of iodine precipitated inside the chamber 241 or inspection and maintenance of the heat exchange fins 242, 242-1, 242-2, 242-3, and 242-4 may be easily performed. At this time, the support sheet 244 may temporarily close the chamber 241.

An opening and closing method of the heat medium plate 243 may be formed of, for example, a hinge structure, a bolt fastening structure, or a sliding structure, and a gasket or a sealing structure may be further included on a coupling surface of the heat medium plate 243 to secure airtightness.

As described above, according to the structures of the support sheet 244 and the heat medium plate 243 according to an embodiment of the present disclosure, arrangement and fixation of the heat exchange fins 242, 242-1, 242-2, 242-3, and 242-4 may be stably maintained, and at the same time, the heat medium plate 243 is allowed to be opened and closed from the chamber 241 during maintenance, thereby improving workability.

In particular, since the heat medium plate 243 may be formed to be openable and closable or detachable, processes such as cleaning of the heat exchange fins 242, 242-1, 242-2, 242-3, and 242-4, inspection of the scraper 251, and iodine removal may be quickly performed, and overall maintenance efficiency and work safety of the apparatus may be secured.

FIG. 14 is a block diagram illustrating an iodine recovery unit 200 including a heat exchange fin structure according to an embodiment of the present disclosure, and an overall operation of the iodine recovery unit may be controlled by a controller 700.

Referring to FIGS. 1, 2, 5, 6 and 14, according to an embodiment of the present disclosure, at least one of the removal units 250 may be operated continuously, and the heater may be controlled to be operated periodically.

For example, the scraper and the vibrator among the removal units 250 may be operated continuously. On the other hand, the heater may be operated periodically based on a predetermined time interval or an accumulated thickness of precipitated iodine.

The heater may perform an auxiliary function of removing iodine remaining on the outer walls of the heat exchange fins 242 by re-vaporizing precipitated solid iodine to convert the solid iodine into a gas, or compensating for efficiency of the removal unit 250 by weakening surface adhesion force. Accordingly, the heater is operated periodically during continuous operation of the scraper and the vibrator, thereby maintaining stability and a recovery rate of the entire system.

According to an embodiment, the scraper and the vibrator may be operated at all times during an operation time of the iodine recovery apparatus, and the heater may be controlled to be automatically operated, for example, at intervals of about 10 minutes or when the thickness of precipitated iodine is 5 mm or more.

As described above, according to an embodiment of the present disclosure, continuous attachment of solid iodine to the outer walls of the heat exchange fins 242 may be prevented through continuous operation of the removal unit 250, and removal of fixed iodine may be repeatedly performed through periodic operation of the heater, thereby improving iodine recovery efficiency of the entire system.

The removal unit 250 according to an embodiment of the present disclosure may be independently installed on each of the heat exchange fins 242, and selective operation for each of the heat exchange fins 242 may be possible.

According to an embodiment, the plurality of heat exchange fins 242 may be installed inside the chamber 241 at intervals spaced apart from each other, and may be arranged in parallel along a flow direction of the mixed gas. Accordingly, since each of the heat exchange fins 242 has an independent heat exchange environment and precipitation condition, the removal unit 250 installed on the heat exchange fins 242 may also be individually operated according to a state of a corresponding heat exchange fin 242.

For example, the scraper 251 may include an independent rotating body 251-1 and blades 251-2 or a moving body 251-3 installed along the outer wall of each heat exchange fin 242, and may be set to operate only when a precipitation amount of a specific heat exchange fin 242 exceeds a reference value. The vibrator 252 may include an ultrasonic vibrator or a rotary motor-based vibrator coupled to each heat exchange fin 242, and the controller 700 may determine whether to operate an individual vibrator by monitoring an iodine adhesion degree or a vibration response of each heat exchange fin 242. The heater 254 may have the heater 254-1 or the heat medium supply unit 254-2 disposed on the outer wall of the heat exchange fin installed in units of each heat exchange fin, and may be periodically operated only for a specific heat exchange fin in which the accumulated thickness of iodine exceeds a reference value.

According to an embodiment, operation control of the removal unit 250 may be automated by sensor-based monitoring. The sensor 255 detects the state of each heat exchange fin 242 in real time through variables such as iodine accumulated thickness, vibration response, temperature change, and scraping resistance, and the controller 700 may determine whether to operate each removal unit 250 based on this.

As described above, according to an embodiment of the present disclosure, since precipitation conditions of the heat exchange fins 242 may vary depending on time and location, the removal unit 250 is allowed to be selectively operated for each heat exchange fin 242, thereby reducing unnecessary operation of the removal unit 250 and minimizing energy consumption and system load.

According to an embodiment of the present disclosure, an operation intensity or an operation frequency of the removal unit 250 may be controlled by the controller 700 according to an increase in a thickness of iodine accumulated on the outer wall of the heat exchange fin 242.

To control the removal unit 250 through the controller 700, a sensor 255 for measuring the accumulated thickness of iodine may be disposed on the outer wall of the heat exchange fin 242. The sensor 255 may be composed of, for example, an optical sensor, a proximity sensor, a capacitive sensor, an infrared sensor, or a combination thereof.

The sensors 255 may be respectively installed to correspond to the removal units 250. For example, a proximity sensor detecting the accumulated iodine thickness at a blade contact position may be installed for the scraper 251, a capacitive sensor attached to the outer wall of the heat exchange fin 242 may be installed for the vibrator 252, and an optical sensor or a heat detection sensor may be installed for the heater 254 to measure the accumulated iodine thickness.

The controller 700 may be implemented as an electronic control unit, includes a CPU, a memory, and an input/output interface, and may transmit and receive sensor data and control signals through the input/output interface.

Accordingly, the sensor 255 may detect the thickness of iodine precipitated and accumulated on the outer wall of the heat exchange fin 242, and the controller 700 may receive a corresponding sensor signal and automatically adjust the operation intensity or operation frequency of the removal unit 250 when the thickness of iodine reaches a reference value or exceeds a reference value.

For example, by the controller 700, in the case of the scraper 251, an operation speed or a number of reciprocations of the blades 251-2 may be increased as the accumulated thickness increases; in the case of the vibrator 252, a vibration frequency or an amplitude may be increased to enhance an iodine separation effect; and in the case of the heater 254, an operation temperature, an operation time, or a heating cycle of the heater 254-1 or the heat medium supply unit 254-2 may be increased to increase detachment efficiency.

Accordingly, according to an embodiment of the present disclosure, by adjusting operation conditions of the removal unit 250 according to an iodine accumulation state, iodine detachment efficiency may be increased, unnecessary operation of the removal unit 250 may be prevented, and energy may be saved.

As described above, the iodine recovery unit 200 including the heat exchange fin structure 240 according to an embodiment of the present disclosure may include the heat medium plate 243 and combines the plurality of removal units 250, thereby stably recovering iodine in the mixed gas through heat exchange and continuously removing iodine precipitated on the outer walls of the heat exchange fins 242. Accordingly, degradation of heat exchange performance due to accumulation of iodine on the heat exchange fins 242 may be prevented, and efficiency of continuous operation and maintenance of the apparatus may be improved.

In the above-described embodiments, the case where the plurality of removal units are applied to the iodine recovery unit of the heat exchange fin structure has been mainly described, but if necessary, the plurality of removal units may also be selectively implemented on a heat exchange inner wall (an inner wall surface of an inner pipe) of the iodine recovery unit of the double pipe structure.

The fluid supply unit 300 according to an embodiment of the present disclosure may selectively supply a cooling medium (e.g., cooling water) or a heating medium (e.g., steam) to each of the plurality of iodine recovery units 200. That is, temperature conditions of each recovery unit 200 may be controlled by the controller 700 by supplying cooling water in a cooling operation state and supplying steam in a heating operation state.

Specifically, the fluid supply unit 300 may be configured with a structure in which a cooling water flow path and a steam flow path are separated, and automatic control may be performed according to operation conditions by combining individual control valves, flow controllers, timers, temperature sensors, etc. The fluid supply unit 300 according to an embodiment is connected to each recovery unit 200 to supply cooling water to one recovery unit and steam to another recovery unit, thereby enabling roles of both recovery units to be performed in parallel. This is illustrated in FIGS. 1, 2, 3, 15 and 16,.

According to an embodiment of the present disclosure, an inner wall temperature of the iodine recovery unit 200 may be controlled to be maintained at 30°C to 50°C through the fluid supply unit 300.

For condensation of iodine (I2), it is necessary to appropriately lower a temperature of a precipitation surface. In an embodiment, an appropriate temperature range in which iodine precipitates as a solid on an inner wall is set to 30°C to 50°C, and the fluid supply unit 300 circulates the cooling medium (e.g., cooling water) to control the temperature in order to stably maintain the corresponding temperature condition.

The fluid supply unit 300 may circulate the cooling medium along the double pipe structure 230 of the iodine recovery unit 200 or the heat medium flow path 243-3 of the heat medium plate 243, and maintain the inner wall temperature of the iodine recovery unit 200 constant.

Referring back to FIGS. 1 and 2, the fluid supply unit 300 may be controlled by the controller 700 to adjust a flow rate and a temperature of a heat medium in conjunction with the iodine recovery unit 200, thereby maintaining or adjusting an internal temperature of the iodine recovery unit 200.

According to an embodiment, the fluid supply unit 300 may set the temperature of the cooling water to a range of about 5°C to 20°C and circulates the cooling water, thereby maintaining the inner wall temperature of the iodine recovery unit 200 at approximately 35°C, resulting in stable precipitation of iodine. When the temperature drops below 30°C, substances other than iodine may also be condensed, and when the temperature exceeds 50°C, precipitation efficiency of iodine decreases sharply.

As described above, according to an embodiment of the present disclosure, by maintaining the inner wall temperature of the iodine recovery unit at 30°C to 50°C, selective precipitation of iodine is induced and condensation of impurities is prevented, thereby improving purity and yield of recovered iodine.

Referring back to FIGS. 1 - 3, the switch 400 according to an embodiment of the present disclosure may be disposed between the mixed gas supply unit 100 and the plurality of iodine recovery units 200, and may be controlled by the controller 700 to selectively switch a flow path of the mixed gas.

Specifically, the switch (e.g., valve) 400 may determine which one of the first iodine recovery unit 210 and the second iodine recovery unit 220 is to be supplied with the mixed gas, and may be automatically operated according to an electric (switching control) signal, a timer, or sensor-based control.

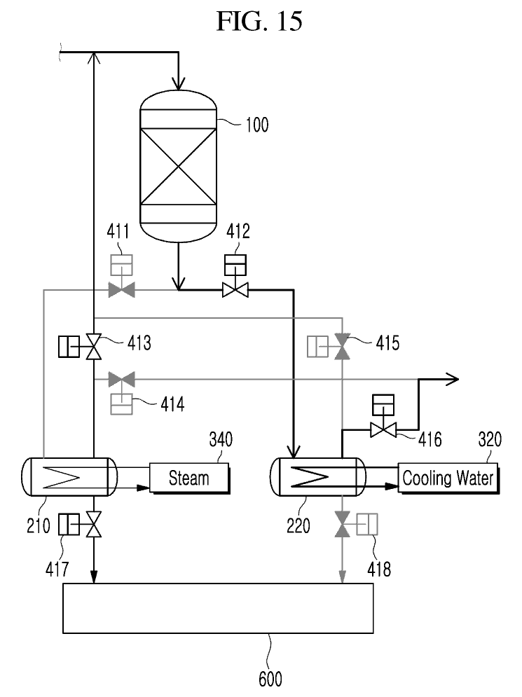

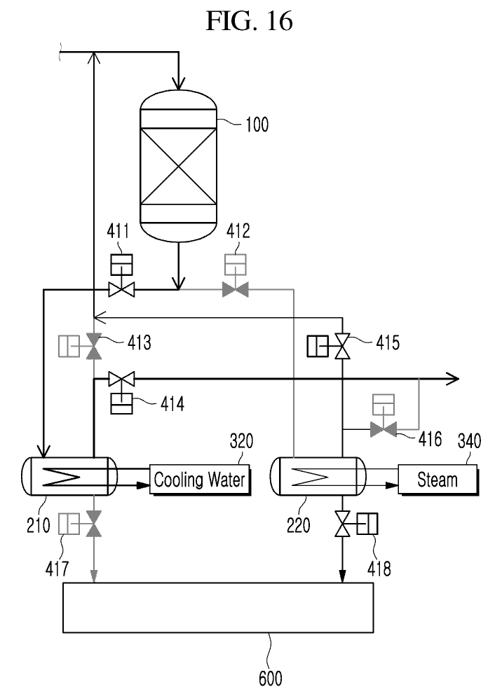

According to an embodiment of the present disclosure, the switch 400 may perform a switch operation (alternating operation) according to a control logic. For example, while the first iodine recovery unit 210 performs precipitation in a cooling state, operation conditions may be switched so that iodine accumulated in the second iodine recovery unit 220 is removed, and thereafter, operation modes of the two recovery units are alternately switched. The switched operation states are shown in FIGS. 15 and 16, respectively.

The switch 400 according to an embodiment of the present disclosure may control the first iodine recovery unit 210 to perform a switch operation for removing the accumulated iodine 10 of the second iodine recovery unit 220 when the first iodine recovery unit 210 is in a cooling operation state.

The switch 400 according to an embodiment of the present disclosure may be disposed between the mixed gas supply unit 100 and the plurality of iodine recovery units 200, and may control an operation mode of each recovery unit by selectively switching a flow path of the mixed gas. The plurality of iodine recovery units 200 may alternately perform a cooling operation state and a heating operation state independently of each other.

Referring to FIGS. 15 and 16, the switches 411 to 416 may control to perform a switch operation for removing the accumulated iodine 10 of the second iodine recovery unit 220 when the first iodine recovery unit 210 is in a cooling operation state. That is, while one of the two recovery units removes accumulated iodine 10 in a heating operation state, the switch 400 switches a corresponding flow path such that the remaining recovery unit receives the mixed gas and performs a cooling operation to precipitate iodine as a solid.

Such an operation may be performed by the switch 400 operating in real time or periodically by a control signal of the controller 700, and the switch operation may be performed after monitoring an iodine accumulation state or an operation time of each recovery unit by the controller 700 or a sensor.

This switch operation enables simultaneous implementation of continuous iodine recovery and accumulated iodine removal in a single apparatus, and maintains iodine recovery efficiency without process interruption.

In an embodiment of the present disclosure, the term "switch operation" is used to include not only a functional concept of switching operation states between the plurality of recovery units 200 but also an operation flow of apparatus configurations performing the corresponding function. Such a switch operation may be automatically performed in conjunction with operations and control of the mixed gas supply unit 100, the recovery unit 200, and the fluid supply unit 300, monitoring of iodine accumulated thickness, etc., as well as simple opening and closing of the switch (e.g., valve) 400.

As described above, according to an embodiment of the present disclosure, by switching a mixed gas supply flow path between the plurality of iodine recovery units so that a heating operation for removing accumulated iodine is performed in another recovery unit while one recovery unit performs a cooling operation for precipitating iodine as a solid, the entire apparatus may be continuously operated.

Accordingly, stable iodine recovery is possible without process interruption, thereby improving iodine recycling efficiency.

According to an embodiment of the present disclosure, the switch 400 may be operated by an electric signal or a timer, and may alternately switch a flow path of the mixed gas based on an accumulation state of iodine or an elapsed operation time.

According to an embodiment, the operation of the switch 400 by the electric signal may be performed by a control signal transmitted from the controller 700 or a sensor. Specifically, a signal generated from a detection unit such as a stack detection sensor, a temperature sensor, or a pressure sensor detecting that iodine is accumulated to a predetermined thickness or more on an internal surface of the iodine recovery unit 200 is transmitted to the controller 700, and opening and closing of the switch 400 may be performed according to this signal. For example, when a thickness of the accumulated iodine 10 becomes 5 mm to 15 mm or more, a corresponding recovery unit is switched from a cooling operation to a heating operation to remove the accumulated iodine, and the switch 400 is operated to supply the mixed gas to a counterpart recovery unit.

According to an embodiment, the operation of the switch 400 by the timer is that the switch 400 switches a supply flow path of the mixed gas at predetermined intervals according to a certain time period. This is operated through a cycle set based on average operation time data required for precipitation and removal of iodine, and a switch operation between the recovery units 200 is periodically performed according to an algorithm prestored in the controller 700. For example, when a cooling operation time is set to 30 minutes, the switch 400 automatically reverses the flow path upon a lapse of 30 minutes to supply the mixed gas to another recovery unit.

Referring back to FIGS. 1 and 2, the switch 400 may be connected to the controller 700, and the controller 700 may include an iodine accumulation detection sensor and a timer circuit. The controller 700 generates an electric signal according to an operation time or an accumulation state of a current recovery unit, and operates the switch 400 through this to control the flow path of the mixed gas to be alternately switched.

As described above, according to an embodiment of the present disclosure, by operating the switch through automatic control based on an electric signal or a timer, the flow path of the mixed gas may be alternately switched based on the accumulation state of iodine or the elapsed operation time. Accordingly, the switch operation between the plurality of iodine recovery units is automated, and continuous and stable iodine recovery is possible without manual intervention of a user.

A time point for switching the second iodine recovery unit 220 to the heating operation according to an embodiment of the present disclosure may be set to a time point when the iodine accumulated thickness reaches 5 mm to 15 mm. Likewise, a time point for switching the first iodine recovery unit 210 to the heating operation by the switch operation may also be set in the same manner.

According to an embodiment, the iodine recovery apparatus may include the first iodine recovery unit 210 and the second iodine recovery unit 220, and is configured to alternately operate each recovery unit by selectively switching the flow path of the mixed gas through the switch 400. At this time, inside the iodine recovery unit 200, iodine (I2) in the mixed gas precipitates and accumulates on an inner wall, and when the accumulated iodine 10 exceeds a certain thickness, recovery is required. Therefore, the heating operation of the first iodine recovery unit 210 or the second iodine recovery unit 220 may be initiated when the iodine accumulated thickness reaches a preset criterion.

According to an embodiment, switching to the heating operation may be performed based on a time point when the iodine accumulated thickness reaches 5 mm. This is because when the thickness reaches 5 mm after iodine accumulates on the inner wall of the recovery unit 200, an effective flow path inside the recovery unit 200 decreases rapidly, which may hinder a flow of the mixed gas or cause degradation of heat transfer efficiency. Accordingly, when the accumulated thickness reaches 5 mm, recovery work is performed by switching to the heating operation to re-vaporize.

The iodine accumulated thickness may be measured in real time through a stack detection sensor such as an optical sensor, an infrared sensor, or a capacitive sensor, and the controller 700 determines a time point when the corresponding thickness reaches 5 mm to 15 mm to control switching to a heating operation mode for the first iodine recovery unit 210 or the second iodine recovery unit 220. After switching, the accumulated iodine 10 in the first iodine recovery unit 210 or the second iodine recovery unit 220 is recovered through liquefaction or vaporization induced by heating, and at the same time, the switch 400 detours the mixed gas to the first iodine recovery unit 210 or the second iodine recovery unit 220, which is a switching target, to switch to a cooling precipitation mode.

As described above, by setting the time point for switching the first iodine recovery unit 210 to the heating operation according to an embodiment of the present disclosure to a time point when the iodine accumulated thickness reaches 5 mm to 15 mm, automation of the recovery process may be realized, and reduction of the flow path or degradation of heat transfer efficiency due to iodine accumulation may be prevented. Through this, process stability and recovery efficiency are improved, and stable recovery efficiency may be guaranteed even during long-term operation of the recovery unit.

According to an embodiment of the present disclosure, the apparatus may include an iodine vaporization delivery line 500 connected to the first iodine recovery unit 210 or the second iodine recovery unit 220 and configured to discharge iodine vaporized in the first iodine recovery unit 210 or the second iodine recovery unit 220 to the mixed gas supply unit 100.

The iodine recovery apparatus may include the mixed gas supply unit 100, the switch 400, the first iodine recovery unit 210, and the second iodine recovery unit 220. The second iodine recovery unit 220 may perform a heating operation alternately with the first iodine recovery unit 210 during a cooling operation, and may vaporize the iodine 10 accumulated on the inner wall. At this time, it is preferable that the vaporized iodine is internally circulated without discharge of waste gas. To this end, the first iodine recovery unit 210 or the second iodine recovery unit 220 may be connected to the mixed gas supply unit 100 by the iodine vaporization delivery line 500.

The iodine vaporization delivery line 500 may be formed of a heat shielding structure or a heating line so that high-temperature iodine vapor is not condensed. For example, a heater, a thermal cable, or the like for preventing condensation of iodine vapor may be included.

The delivered vaporized iodine may be mixed again with halogen-based hydrocarbons in the mixed gas supply unit 100 to generate a new mixed gas, and thereafter, the recovery process is repeatedly performed.

As described above, according to an embodiment of the present disclosure, by directly discharging iodine vaporized by heating in the first iodine recovery unit or the second iodine recovery unit to the mixed gas supply unit, internal circulation of iodine may be possible, thereby increasing a reuse rate of raw materials and reducing operation costs.

FIG. 3 is a schematic diagram illustrating connection relationships between main components and an overall process flow of an apparatus for iodine recovery according to an embodiment of the present disclosure.

An apparatus for iodine recovery according to an embodiment may include a mixed gas supply unit 100 configured to supply a mixed gas containing iodine, a first iodine recovery unit 210 and a second iodine recovery unit 220 configured to precipitate iodine as a solid from the mixed gas, fluid supply units 320 and 340 configured to selectively supply cooling water or steam and a plurality of switches 411 to 416 configured to switch flow paths of the mixed gas.

The switches 411 and 412 are switches that open and close flow paths branching from the mixed gas supply unit 100 to the first iodine recovery unit 210 and the second iodine recovery unit 220, respectively, and only one is opened and the other is closed according to a cooling or heating operation of the recovery unit 200.

The switches 413 and 415 may control opening and closing of the iodine vaporization delivery line 500 discharging iodine vaporized in the recovery unit 200.

The switches 414 and 416 may control opening and closing of flow paths through which cooling water or steam is supplied from the fluid supply units 320 and 340 to each recovery unit. When cooling water is supplied, the valve 414 is opened, and when steam is supplied, the valve 416 is opened.

The switches 417 and 418 may control opening and closing of flow paths for delivering iodine liquefied in the recovery unit 200 to the liquid iodine recovery tank 600.

FIG. 15 illustrates a state in which the first iodine recovery unit 210 is in a cooling operation mode and the second iodine recovery unit 220 is in a heating operation mode in the apparatus for iodine recovery according to an embodiment of the present disclosure. This is a mode generally used in a state before a switch operation or in an initial operation stage.

The switch 411 may be opened to supply the mixed gas from the mixed gas supply unit 100 to the first iodine recovery unit 210, and the other switch 412 may be closed to block supply of the mixed gas to the second iodine recovery unit 220.

Another switch 413 may be closed to block the iodine vaporization delivery line 500 of the first iodine recovery unit 210.

Cooling water may be supplied from the cooling water supply unit 320 to the first iodine recovery unit 210, and another switch 414 may be opened.

Another switch 415 may be opened to discharge iodine vaporization gas generated in the second iodine recovery unit 220.

Steam may be supplied from the steam supply unit 340 to the second iodine recovery unit 220, and another switch 416 may be opened.

Another switch 417 may be closed, and another switch 418 may be opened, so that iodine liquefied in the second iodine recovery unit 220 can be collected in the liquid iodine recovery tank 600.

As described above, the first iodine recovery unit 210 may perform a cooling operation of precipitating iodine as a solid by cooling the mixed gas, and the second iodine recovery unit 220 may perform a heating operation of removing accumulated iodine by vaporizing it with steam.

FIG. 16 illustrates a state in which the first iodine recovery unit is switched to a heating operation mode and the second iodine recovery unit is switched to a cooling operation mode in the apparatus for iodine recovery according to an embodiment of the present disclosure.

Referring to FIG. 16, it can be seen that as an operation mode after the switch operation, the first iodine recovery unit 210 may be switched to the heating operation mode and the second iodine recovery unit 220 may be switched to the cooling operation mode. This is a state in which the operation mode is switched automatically or manually when iodine is accumulated to a certain thickness (e.g., 5 mm) or more.

The switch 411 may be closed to block supply of the mixed gas to the first iodine recovery unit 210 and supply the mixed gas to the second iodine recovery unit 220.

The other switch 412 may be opened to supply the mixed gas from the mixed gas supply unit 100 to the second iodine recovery unit 220.

Another switch 413 may be opened to discharge iodine vaporization gas generated in the first iodine recovery unit 210.

Steam may be supplied from the steam supply unit 340 to the first iodine recovery unit 210, and another switch 414 may be closed.

Another switch 415 may be closed to block the iodine vaporization delivery line 500 of the second iodine recovery unit 220.

Cooling water may be supplied from the cooling water supply unit 320 to the second iodine recovery unit 220, and another switch 416 may be opened.

As described above, the second iodine recovery unit 220 may perform a cooling operation of precipitating iodine as a solid by cooling the mixed gas, and the first iodine recovery unit 210 may perform a heating operation of removing accumulated iodine 10 by vaporizing it with steam.

Another switch 417 may be opened, and another switch 418 may be closed, so that iodine liquefied in the first iodine recovery unit 210 can be collected in the liquid iodine recovery tank 600.

Switching of these switches may be performed synchronously by a control signal of the controller 700, and opening and closing operations of each valve may be automatically performed based on a logic or sensor data stored in the controller 700.

As described above, the apparatus for iodine recovery according to an embodiment of the present disclosure effectively precipitates and removes iodine from the mixed gas, thereby enabling high-efficiency iodine recovery, prevention of accumulation, and recovery of iodine without downtime of facilities in a continuous process environment.

In particular, continuous and stable operation is possible through a dual operation structure of a plurality of recovery units capable of independently performing cooling and heating operations and a switch-based switch operation, and recovery efficiency may be maintained without process stoppage.

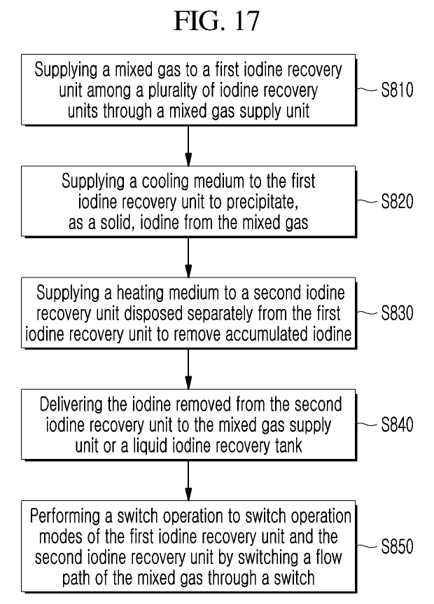

FIG. 17 is a flowchart illustrating main steps of a method for iodine recovery according to an embodiment of the present disclosure. In the method for iodine recovery according to an embodiment of the present disclosure, descriptions of parts partially overlapping with the above-described apparatus for iodine recovery will be omitted.

As shown in FIG. 17, a method for precipitating and recovering iodine as a solid from a mixed gas containing iodine may include supplying a mixed gas to a first iodine recovery unit among a plurality of iodine recovery units through a mixed gas supply unit (S810), supplying cooling medium to the first iodine recovery unit to precipitate iodine as a solid (S820), removing accumulated iodine for a second iodine recovery unit disposed separately from the first iodine recovery unit (S830), vaporizing the iodine removed from the second iodine recovery unit and delivering the vaporized iodine to the mixed gas supply unit or a liquid iodine recovery tank (S840) and performing a switch operation of switching operation modes of the first iodine recovery unit and the second iodine recovery unit by switching a flow path of the mixed gas through a switch (S850).

This relates to a method for precipitating and recovering iodine as a solid from a mixed gas containing iodine, and in particular, enables continuous iodine recovery through alternating operation for the first iodine recovery unit and the second iodine recovery unit.

The operation of supplying a mixed gas to a first iodine recovery unit among a plurality of iodine recovery units through a mixed gas supply unit (S810) according to an embodiment of the present disclosure includes a process of supplying a mixed gas containing iodine to the first iodine recovery unit to form a flow path for precipitating iodine as a solid in a cooling environment.

The mixed gas supply unit may generate a mixed gas containing iodine (I2) and halogen-based hydrocarbons and supplies the mixed gas to the first iodine recovery unit through a switch, and the corresponding unit may be set to a cooling operation mode. The mixed gas used herein may flow into the recovery unit through a supply line as shown in FIGS. 3, 15 and 16.

The operation of supplying cooling water to the first iodine recovery unit to precipitate iodine as a solid (S820) according to an embodiment of the present disclosure includes a process of supplying cooling water into the first iodine recovery unit through a fluid supply unit. For example, condensation and precipitation of iodine may be induced by maintaining an inner wall temperature of the recovery unit at 30°C to 50°C.

According to an embodiment, cooling water may be supplied to the heat exchanger of the double pipe structure 230 and the heat exchange fin structure of FIGS. 4 and 5 to 14. At this time, iodine accumulates on an inner wall of the recovery unit, and an accumulation rate may vary depending on iodine concentration or flow rate in the mixed gas.

The operation of removing accumulated iodine for a second iodine recovery unit disposed separately from the first iodine recovery unit (S830) according to an embodiment of the present disclosure includes a process for removing iodine accumulated during a cooling operation of a previous cycle in the second iodine recovery unit configured independently from the first iodine recovery unit currently in the cooling operation.

Iodine removal proceeds by a heating operation, and steam may be supplied to raise the inner wall temperature of the recovery unit to convert solid iodine into a liquid or gas state.

The operation of delivering the iodine removed from the second iodine recovery unit to the mixed gas supply unit if it is in a gas state, and to a liquid iodine recovery tank if it is in a liquid state (S840) according to an embodiment of the present disclosure includes a process of transporting iodine vaporized or liquefied in the previously heated second iodine recovery unit to the mixed gas supply unit through an iodine vaporization delivery line or delivering it to the liquid iodine recovery tank.

In some embodiments, the iodine vaporization delivery line may be heated to prevent condensation, and the recovered iodine is supplied to a reactor or the like of the mixed gas supply unit and recycled.

The operation of performing a switch operation of switching operation modes of the first iodine recovery unit and the second iodine recovery unit by switching a flow path of the mixed gas through a switch (S850) according to an embodiment of the present disclosure includes a process of controlling the switch so that the cooling operation and the heating operation of the first iodine recovery unit and the second iodine recovery unit are alternately performed.

The switch may be controlled by an electric signal or a timer, and the mixed gas flow path is alternately switched according to a control signal flow of the switches 411 to 416. Due to this, while one recovery unit performs a cooling operation, the other recovery unit performs a heating operation to remove iodine, and continuous operation is possible by subsequently switching the operation mode.

As described above, the method for iodine recovery according to an embodiment of the present disclosure may continuously perform precipitation and removal of iodine by alternating operation modes of the first iodine recovery unit and the second iodine recovery unit, thereby enabling a sustainable recovery process without separate interruption. Through this, iodine recovery efficiency and an operation rate of the apparatus may be improved, and continuity and productivity of the entire process may be secured.

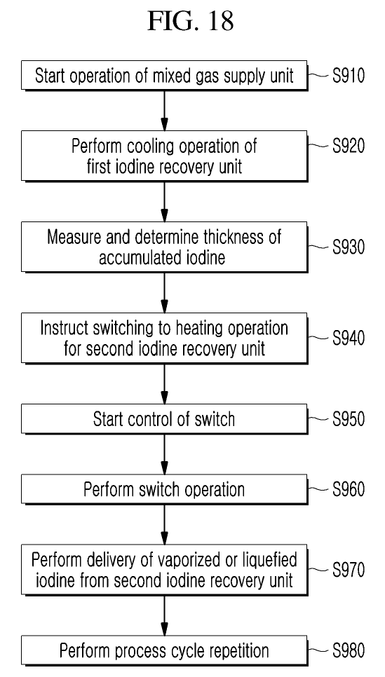

FIG. 18 is a flowchart illustrating an overall control flow regarding switch control including performance of a switch operation and iodine discharge in the method for iodine recovery according to an embodiment of the present disclosure.

In the operation of starting operation of the mixed gas supply unit (S910), the mixed gas supply unit may operate to start supplying a mixed gas containing iodine to a first iodine recovery unit among a plurality of iodine recovery units.

In the operation of performing a cooling operation of the first iodine recovery unit (S920), a cooling operation of precipitating iodine as a solid may be performed while maintaining an inner wall temperature at 30°C to 50°C by supplying cooling water to the first iodine recovery unit.

In the operation of measuring and determining an iodine accumulated thickness (S930), a thickness of iodine accumulated in a second iodine recovery unit may be measured in real time, and it may be determined whether the thickness reaches 5 mm.

In the operation of instructing switching to a heating operation of the second iodine recovery unit (S940), when the iodine accumulated thickness reaches 5 mm, the controller may instruct the second iodine recovery unit to switch to a heating operation to vaporize the accumulated iodine.

In the operation of starting control of the switch (S950), the controller may control the switch to stop the operation of the first iodine recovery unit, and may switch an operation mode by switching a supply path of the mixed gas to the second iodine recovery unit.

In the operation of performing a switch operation (S960), the controller may perform a switch operation of alternating operation modes of the first iodine recovery unit and the second iodine recovery unit by opening and closing flow paths through the switch.

In the operation of performing iodine vaporization or liquefaction delivery in the second iodine recovery unit (S970), iodine vaporized in the second iodine recovery unit may be delivered to the mixed gas supply unit through the iodine vaporization delivery line and re-supplied together with the mixed gas, or iodine liquefied in the second iodine recovery unit may be delivered to the liquid iodine recovery tank.

In the operation of performing process circulation repetition (S980), the process may be cyclically controlled by the controller to repeatedly perform the series of steps so that iodine is continuously recovered.

As described above, in the overall process shown in FIG. 18, cooling precipitation, heating vaporization or liquefaction, switch control, and discharge steps are continuously performed based on the switch operation, thereby efficiently recovering iodine from the mixed gas containing iodine.

The contents described above are merely examples applying the principles of the present disclosure, and other configurations may be further included without departing from the scope of the present disclosure. For example, at least some of the various embodiments of the present disclosure described above may be combined.

What is claimed is:

1. An apparatus for iodine recovery, comprising:
a mixed gas supply unit configured to supply a mixed gas containing iodine;
a plurality of iodine recovery units configured to receive the mixed gas and precipitate, as a solid, the iodine from the mixed gas;
a fluid supply unit configured to selectively supply a cooling medium or a heating medium to each of the plurality of iodine recovery units; and
a switch disposed between the mixed gas supply unit and the plurality of iodine recovery units, configured to selectively switch a flow path of the mixed gas,
wherein the plurality of iodine recovery units includes a first iodine recovery unit and a second iodine recovery unit, and wherein the first iodine recovery unit precipitates, as a solid, the iodine in a cooling operation state, and the second iodine recovery unit removes accumulated iodine in a heating operation state.

2. The apparatus of claim 1,
wherein each of the plurality of iodine recovery units comprises at least one of a double pipe structure or a heat exchange fin structure,
wherein, in the double pipe structure, the mixed gas flows along an inner pipe, cooling water flows along an outer pipe, and the iodine precipitates on an inner wall of the inner pipe, and
wherein, in the heat exchange fin structure, a plurality of heat exchange fins are disposed inside a chamber, and the iodine precipitates while the mixed gas flows along outer circumferential surfaces of the plurality of heat exchange fins.

3. The apparatus of claim 2,
wherein the iodine recovery unit having the heat exchange fin structure comprises:
the chamber having a mixed gas inlet at one side and a mixed gas outlet at an opposite side;
a heat medium plate disposed at an upper side of the chamber and having a heat medium flow path inside the heat medium plate;
the plurality of heat exchange fins disposed inside the chamber, wherein the plurality of heat exchange fins are connected to the heat medium plate to exchange heat with a heat medium flowing through the heat medium flow path, or are fluidly connected to the heat medium flow path such that the heat medium flows inside the plurality of heat exchange fins; and
a plurality of removal units disposed on an outer side of the plurality of heat exchange fins and configured to remove iodine precipitated on outer walls of the plurality of heat exchange fins from the mixed gas, wherein the plurality of removal units comprise at least two of a scraper, a vibrator, a coating part, and a heater.

4. The apparatus of claim 3,
wherein the scraper comprises: a rotating body rotatably installed on outer circumferential surfaces of the plurality of heat exchange fins; and a plurality of blades coupled to the rotating body and fixed to the outer walls of the plurality of heat exchange fins, or coupled to the rotating body and moving along the outer walls of the plurality of heat exchange fins to scrape precipitated iodine, or
wherein the scraper is configured to scrape the precipitated iodine on the outer walls of the plurality of heat exchange fins by a moving body slidably installed on the outer circumferential surfaces of the plurality of heat exchange fins.

5. The apparatus of claim 3, wherein the vibrator comprises a vibration generating unit coupled to the plurality of heat exchange fins, and wherein the vibration generating unit comprises an ultrasonic vibrator or a rotary motor-based vibrator.

6. The apparatus of claim 3, wherein the coating part comprises an antifouling or water-repellent coating layer formed on the outer walls of the plurality of heat exchange fins, and wherein the coating layer is formed of a single layer or multiple layers including at least one of tetrafluoroethylene (TFE), polytetrafluoroethylene (PTFE), perfluoroalkoxy alkane (PFA), fluorinated ethylene propylene (FEP), polyethylene terephthalate (PET), or polydimethylsiloxane (PDMS).

7. The apparatus of claim 3, wherein the chamber comprises a partition wall or a porous baffle disposed between the plurality of heat exchange fins and configured to control a flow of the mixed gas.

8. The apparatus of claim 1, wherein the switch is configured to perform a switch operation to remove accumulated iodine from the second iodine recovery unit when the first iodine recovery unit is operated in a cooling operation state.

9. The apparatus of claim 8, wherein the switch is operated by an electric switching control signal or a timer, and is configured to alternately switch a flow path of the mixed gas based on an accumulation state of the iodine or an elapsed operation time.

10. The apparatus of claim 1, further comprising a controller configured to control operations of the switch and the fluid supply unit, wherein the controller is configured to control the switch to selectively switch a flow path of the mixed gas, and control the fluid supply unit to selectively supply the cooling medium or the heating medium to each of the plurality of iodine recovery units.

11. The apparatus of claim 1, wherein a time point for switching the first iodine recovery unit or the second iodine recovery unit to a heating operation is set to a time when a thickness of accumulated iodine reaches a set thickness.

12. The apparatus of claim 1, further comprising:
an iodine vaporization delivery line connected to the first iodine recovery unit or the second iodine recovery unit and configured to deliver iodine vaporized from the first iodine recovery unit or the second iodine recovery unit to the mixed gas supply unit; or
a liquid iodine recovery tank configured to recover iodine liquefied in the first iodine recovery unit or the second iodine recovery unit.

13. A method for iodine recovery, comprising:
supplying a mixed gas to a first iodine recovery unit among a plurality of iodine recovery units through a mixed gas supply unit;
supplying a cooling medium to the first iodine recovery unit to precipitate, as a solid, iodine from the mixed gas;
supplying a heating medium to a second iodine recovery unit disposed separately from the first iodine recovery unit to remove accumulated iodine;
delivering the iodine removed from the second iodine recovery unit to the mixed gas supply unit or a liquid iodine recovery tank; and
performing a switch operation to switch operation modes of the first iodine recovery unit and the second iodine recovery unit by switching a flow path of the mixed gas through a switch.

14. The method of claim 13, further comprising: supplying the cooling medium to the second iodine recovery unit to precipitate, as a solid, the iodine by the switch operation,
wherein the supplying the cooling medium to the first iodine recovery unit to precipitate, as a solid, the iodine or supplying the cooling medium to the second iodine recovery unit to precipitate, as a solid, the iodine by the switch operation is performed through:
a double pipe structure in which the mixed gas flows along an inner pipe, cooling water flows along an outer pipe, and the iodine precipitates as a solid on an inner wall of the inner pipe; or
a heat exchange fin structure in which the mixed gas flows along outer circumferential surfaces of a plurality of heat exchange fins disposed inside a chamber, and the iodine precipitates as a solid on the outer circumferential surfaces of the plurality of heat exchange fins.

15. The method of claim 14,
the supplying the cooling medium to the first iodine recovery unit to precipitate, as a solid, the iodine or supplying the cooling medium to the second iodine recovery unit to precipitate, as a solid, the iodine by the switch operation is performed through wherein the iodine recovery unit having the heat exchange fin structure comprises:
the chamber having a mixed gas inlet at one side and a mixed gas outlet at an opposite side;
a heat medium plate disposed at an upper side of the chamber and having a heat medium flow path inside the heat medium plate;
the plurality of heat exchange fins disposed inside the chamber, wherein the plurality of heat exchange fins are connected to the heat medium plate to exchange heat with the heat medium flowing through the heat medium flow path, or are fluidly connected to the heat medium flow path such that the heat medium flows inside the plurality of heat exchange fins; and
a plurality of removal units disposed on an outer side of the plurality of heat exchange fins and configured to remove iodine precipitated on outer walls of the plurality of heat exchange fins from the mixed gas, wherein the plurality of removal units comprise at least two of a scraper, a vibrator, a coating part, and a heater.

16. The method of claim 13, wherein the switch operation is controlled by an electric switching control signal or a timer, and alternately switches a flow path of the mixed gas based on an accumulation state of iodine or an elapsed operation time.

17. The method of claim 13, wherein operations of the switch and a fluid supply unit supplying the cooling medium or the heating medium are controlled by a control signal from a controller.

18. The method of claim 17, wherein an inner wall temperature of the iodine recovery unit is controlled to be maintained at a range from 30°C to 50°C through the fluid supply unit.

19. The method of claim 13, wherein a time point for switching the first iodine recovery unit or the second iodine recovery unit to a heating operation is set to a time when a thickness of accumulated iodine reaches a set thickness.

20. The method of claim 13, further comprising delivering iodine vaporized in the first iodine recovery unit or the second iodine recovery unit to the mixed gas supply unit through an iodine vaporization delivery line.
